(19) United States
(12) Patent Application Publication
(10) Pub. No.: US 2011/0076463 A1
(43) Pub. Date: Mar. 31, 2011

(54) MATTE RESIN FILM

(75) Inventor: Norio SUGIMURA, Niihama-shi (JP)

(73) Assignee: Sumitomo Chemical Company, Limited, Tokyo (JP)

(21) Appl. No.: 12/569,451

(22) Filed: Sep. 29, 2009

(51) Int. Cl. B32B 3/10; B32B 27/30; B32B 5/16; B32B 27/08; B32B 5/00

(52) U.S. Cl. 428/195.1; 428/411.1; 428/323; 428/522; 428/520; 428/220

(57) ABSTRACT

The present invention provides a matte resin film having a matte surface which allows a printed pattern to be clearly seen through a matte surface when the pattern is on a surface of the matte resin film opposite to the matte surface. The matte resin film has a resin film substrate and a matte layer formed on at least one surface of the resin film substrate, wherein the matte layer has a top surface that has a 60-degree specular gloss Gs being 5% to 60%, and wherein the matte resin film has a haze H that satisfies the inequality: H<70(%)−Gs. Preferably, the matte layer contains a transparent resin and transparent fine particles dispersed therein.

### BACKGROUND OF THE INVENTION

The present invention relates to a matte resin film having a matte layer formed on a surface of a resin film substrate. The present invention also relates to a marking film comprising the matte resin film. Furthermore, the present invention relates to a multilayer film or sheet comprising the matte resin film laminated on a film or sheet, and a laminated article comprising the matte resin film or the multilayer film or sheet laminated on a surface of a molded article made of a thermoplastic resin.

Conventionally, a plastic plate such as an acrylic resin plate or a polycarbonate resin plate is generally used as a substrate which is subject to a matting treatment. For example, a surface of the substrate is matted by thermoforming, and the substrate is used as a decorative molded body. In these years, as a method for producing such a highly decorative molded body, a film-lamination method such as a simultaneous injection molding-lamination method has been frequently employed, and has been increasingly required for the matted resin films.

As a matte resin film, a film produced by transferring a matte pattern onto a surface of the film, or a film produced by kneading a delusterant in a resin is known (see JP-A-3-237134 and JP-A-10-237261). In addition, JP-A-2003-211598 proposes a matte resin film having, on its surface, a matte layer (a delustered layer) made of a thermosetting resin or a photocurable resin and inorganic fine particles.

Often employed are matte resin films having design patterns being printed on a surface of the matte resin film opposite to the matte surface in order to enhance a designability of a molded article on which the matte resin film is laminated. However, the conventional matte resin films have a drawback that a pattern tends to be seen cloudy and unclear when it is viewed through the matte surface.

### SUMMARY OF THE INVENTION

An object of the present invention is to provide a matte resin film which allows a printed pattern, if any, to be clearly seen through the matte surface when the pattern is printed on a surface, opposite to the matte surface, of the matte resin film.

As a result of extensive studies, the inventor of the present application has found that a matte resin film having a matte layer formed on a surface of a resin film substrate and having a specific gloss and a specific haze is suitable for achieving the above object. The present invention has been completed based on such a finding.

Accordingly, the present invention provides a matte resin film comprising: a resin film substrate; and a matte layer formed on at least one surface of the resin film substrate, wherein the matte layer has a top surface that has a 60-degree specular gloss Gs being in a range of 5% to 60%, and wherein the matte resin film has a haze H that satisfies the following inequality: H<70%−Gs.

The resin film substrate (hereinafter referred to as “film substrate” merely) means a film substrate made of a thermoplastic resin substantially without containing a delusterant agent.

The matte layer means a layer made of a delusterant agent and a transparent resin which has a finely uneven surface, and is positioned at the outermost of the matte resin film.

Examples of the delusterant include, for example, transparent fine particles and so forth.

According to the matte resin film, it is possible to impart designability to the film, for example, by forming the matte layer on one surface of the film substrate and subsequently printing a pattern on the other surface of the matte layer. In this case, if an adhesive layer is formed on the pattern-printed surface, the matte resin film can be used as a marking film. Furthermore, a multilayer film or sheet can be formed by laminating another film or sheet on the surface of the matte resin film opposite to the matte layer. Moreover, a laminated article having an excellent designability can be produced by laminating the matte resin film or the multilayer film or sheet on a thermoplastic resin molded article in such a manner that the matte layer lies at a surface of the laminate molded article.

A laminated article having a good designability can be obtained by using the matte resin film according to the present invention. This is because a printed pattern, if any, can be clearly seen through the matte surface when the pattern is printed on the surface of the matte resin film opposite to the matte surface.

### BRIEF DESCRIPTION OF THE DRAWING

FIG. 1 is a schematic cross-sectional view showing one example of a layer structure of a matte resin film according to the present invention.

1 film substrate,
3 rubber particles,
5 matte layer,
7 surface opposite to the matte layer,
10 matte film.

### DETAILED DESCRIPTION OF THE PREFERRED EMBODIMENTS

The matte resin film according to the present invention has a matte layer formed on at least one surface of a resin film substrate, and the 60-degree specular gloss Gs of the surface of the matte layer is from 5 to 60%, preferably from 10% to 50%, and more preferably from 20% to 40%. If the Gs is lower than 5%, the matting effect becomes so high that it is difficult to maintain the transparency of the film, and as a result, the film tends to be seen dull white. Thus, a printed pattern, if any, which is viewed through the matte surface tends to be seen cloudy and unclear, when the pattern is on the surface of the matte resin film opposite to the matte surface. If the Gs exceeds 60%, the matting effect is not sufficient.

In addition, the matte resin film according to the present invention has a haze H satisfying the inequality: H<70(%)−Gs, preferably the inequality: H<68(%)−Gs, and more preferably the inequality: H<65(%)−Gs. When the H and the Gs satisfy the above inequality, the matte resin film of the present invention can obtain an excellent transparency property and thus a pattern printed on the surface of the matte resin film opposite to the matte surface is clearly seen through the matte surface.

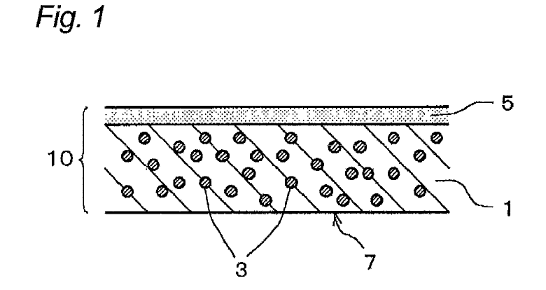

A preferred example of the layer structure of the matte resin film according to the present invention is shown in FIG. 1 as a schematic cross-sectional view. In this example, a matte layer 5 is formed on one surface of a film substrate 1. Also, in this example, the film substrate 1 is made of a resin composition containing rubber particles 3 dispersed in a matrix of the resin.

The matte resin film of the present invention having the predetermined optical properties described above can be produced by adjusting a composition and a thickness of each of the film substrate 1 and the matte layer 5.

Examples of the resin composing the film substrate 1 include, for example, acrylic resins, styrene resins, vinyl chloride resins, olefin resins, polyurethane resins, polyester resins, polycarbonate resins, and the like. From a point of view of transparency and weather resistance, preferably used are acrylic resins, and particularly, a resin composition containing: a polymer mainly comprising an alkyl methacrylate as a matrix resin; and acrylic rubber particles dispersed in the matrix resin (an impact resistant acrylic resin).

The polymer mainly comprising the alkyl methacrylate means a polymer prepared by polymerizing a monomer containing 50% or more by weight of an alkyl methacrylate. Specific examples of such a polymer may include homo-poly(alkyl methacrylate), i.e., polymers consisting essentially only of an alkyl methacrylate, copolymers of two or more alkyl methacrylates, and copolymers of an alkyl methacrylate and a monomer which is copolymerizable with the alkyl methacrylate (for example, such as an acrylate ester, etc). The alkyl methacrylate may preferably have about 1 to 4 carbon atoms in its alkyl moiety. In particular, methyl methacrylate is preferable. In the case of a copolymer of an alkyl methacrylate and an acrylate ester, specific examples of the acrylate ester, as the copolymerizable monomer, include alkyl acrylates having preferably about 1 to 10 carbon atoms in their alkyl moieties. Specific examples of the alkyl acrylates include, for example, methyl acrylate, ethyl acrylate, propyl acrylate, isopropyl acrylate, butyl acrylate, isobutyl acrylate, hexyl acrylate, octyl acrylate, 2-ethylhexyl acrylate, etc.

In case of the copolymer of an alkyl methacrylate and an alkyl acrylate, the copolymer preferably contains about 50 to about 99.5% by weight of alkyl methacrylate units and about 50 to about 0.5% by weight of alkyl acrylate units. Furthermore, the copolymer may optionally contain other monomer units as a copolymer component in an amount that can not adversely affect the effect of the present invention.

The polymer mainly comprising the alkyl methacrylate preferably has a glass transition temperature of from 60° C. to 110° C. and a weight-average molecular weight of from 70,000 to 600,000. The glass transition temperature is more preferably not less than 75° C. nor more than 105° C. The weight-average molecular weight is more preferably not less than 120,000 nor more than 300,000. Here, the glass transition temperature may be measured with a differential scanning calorimeter usually in a nitrogen atmosphere at a heating rate of 10° C./min. The weight-average molecular weight may be measured by gel permeation chromatography (GPC).

When the glass transition temperature is excessively low, the film may not have a desirable surface hardness. When the weight-average molecular weight is excessively low, the melt viscosity of the polymer becomes so low that a molding processability for forming the film is deteriorated and also a moldability is deteriorated when the matte film is used in the simultaneous injection molding-lamination method. Accordingly, a precise thickness of the film or a surface matting property may not be obtained. When the weight-average molecular weight is excessively high, the melt viscosity of the polymer becomes so high that the moldability for forming the film is deteriorated and also gel-like materials generate in the obtained film, and therefore some problems tend to easily arise. While acrylic resins usually have a glass transition temperature of about 30° C. to 110° C., acrylic resins having a glass transition temperature of from 60° C. to 110° C. are properly selected for use in the present invention. Since the glass transition temperature of the acrylic resin is substantially determined in accordance with the composition of monomers composing the resin, the monomer composition may be adjusted so that the glass transition temperature may be set within the above range.

As the polymer mainly comprising the alkyl methacrylate, a polymer prepared by polymerization may be used alone, or alternatively a mixture of two or more polymers having different weight-average molecular weights may be used. In particular, when it is desired to increase a surface hardness of the film, a mixture containing at least one polymer component having a weight-average molecular weight of 70,000 to 200,000 may be used. Furthermore, when it is desired to improve both the surface hardness and the moldability which can suppress a generation of unevenness during thermoforming after a film formation, it is advantageous to use a mixture containing at least one polymer component having a weight-average molecular weight of from 70,000 to 200,000 and at least one polymer component having a weight-average molecular weight of from 150,000 to 700,000. A chart of the weight-average molecular weight, measured by GPC, of such a mixture shows a peak spreading towards its foot or a peak having a shoulder. Preferably, the polymer component having the weight-average molecular weight of from 70,000 to 200,000 has a glass transition temperature of about 90° C. to about 110° C., and the polymer component having the weight-average molecular weight of from 150,000 to 700,000 has a glass transition temperature of about 40° C. to about 80° C.

Acrylic rubber particles may comprise a rubber elastic material prepared by copolymerizing an alkyl acrylate having 4 to 8 carbon atoms in its alkyl moiety, a polyfunctional monomer and optionally other monofunctional monomers. As an alternative to the acrylic rubber particles having a monolayer structure made of such a copolymer, acrylic rubber particles having a multilayer structure containing such a copolymer in one layer of the multilayer structure may also be used. The polyfunctional monomer used herein may be a compound having at least two polymerizable carbon-carbon double bonds in a molecule. Examples of the polyfunctional monomer include alkenyl esters of unsaturated carboxylic acids, such as allyl (meth)acrylate and methallyl (meth)acrylate; dialkenyl esters of dibasic acids, such as diallyl maleate; and diesters of unsaturated carboxylic acids with glycol, such as alkylene glycol di(meth)acrylate; and the like. Examples of the other monofunctional monomers used as an optional copolymer component include, for example, styrene, nuclear alkyl-substituted styrene, α-methylstyrene, acrylonitrile, etc.

The acrylic rubber particles having a multilayer structure containing a rubber elastic material, which are prepared by copolymerizing a monomer mixture comprising as an essential component an alkyl acrylate and a polyfunctional monomer, may be particles having: a layer of the rubber elastic material including the copolymer made of, for example, the alkyl acrylate and the polyfunctional monomer as a mandatory monomer; and a hard layer formed of a polymer mainly comprising methyl methacrylate, the hard layer being formed around the layer made of the rubber elastic material. The acrylic rubber particles having a multilayer structure may have two, three or more layers. Examples of the acrylic rubber particles having a two-layer structure include particles having: an inner layer made of a rubber elastic material prepared by copolymerizing a monomer mixture containing essentially an alkyl acrylate and a polyfunctional monomer, and an outer layer made of a hard polymer mainly comprising methyl methacrylate. Examples of acrylic rubber particles having a three-layer structure include particles having: an innermost layer made of a hard polymer mainly comprising methyl methacrylate, an intermediate layer made of a rubber elastic material prepared by copolymerizing a monomer mixture containing essentially an alkyl acrylate and a polyfunctional monomer, and an outermost layer made of a hard polymer mainly comprising methyl methacrylate. The innermost layer is preferably crosslinked using a small amount of a polyfunctional monomer in addition to methyl methacrylate. Such acrylic rubber particles having a three-layer structure can be produced by a method described in, for example, JP-A-55-27576 (corresponding to U.S. Pat. No. 3,793,402), the disclosure of which is hereby incorporated by reference. In the present invention, rubber particles having a multilayer structure of at least two layers are preferably used. More preferably, rubber particles having a three-layer structure is used from a viewpoint of an improvement in the surface hardness of the film.

An average particle diameter of the acrylic rubber particles is usually about 50 to about 500 nm, preferably about 80 nm or more, and more preferably about 150 nm or more. The average particle diameter of the acrylic rubber particles is preferably about 350 nm or less, and more preferably about 300 nm or less. When the average particle diameter is excessively small, an impact resistance of the resultant film tends to deteriorate. On the other hand, when it is excessively large, a transparency of the film tends to decrease.

When the acrylic rubber particles having an outermost layer made of a hard polymer of a monomer mainly comprising methyl methacrylate, and a rubber elastic material surrounded by the outermost layer, are mixed with a matrix acrylic resin, the outermost layer of the rubber particles immingles with the matrix resin. Thus, when the rubber component is dyed with ruthenium oxide and subsequently a cross-sectional surface thereof is observed with an electron microscope, each of rubber particles is observed as if the outermost layer thereof is eliminated. Specifically, when acrylic rubber particles having a two-layer structure which consists of an inner layer made of a rubber elastic material, and an outer layer made of a hard polymer mainly comprising methyl methacrylate, the rubber elastic material portion is dyed and observed as if the particles have a single layer structure. When acrylic rubber particles having a three-layer structure which consists of an innermost layer made of a hard polymer mainly comprising methyl methacrylate, an intermediate layer made of a rubber elastic material, and an outermost layer made of a hard polymer mainly comprising methyl methacrylate, a center part of each of the particles, that is, the innermost layers, is not dyed and only a rubber elastic material portion, that is, the intermediate layer is dyed and therefore observed as if the particles have a two-layer structure. Herein, an average diameter of the rubber particles means a number-average value of a diameter of the dyed portion which is observed as a substantially circular shape when the rubber particles are mixed with the matrix resin and the cross-sectional surface of the mixture is dyed with ruthenium oxide.

As to the ratio of the polymer mainly comprising the alkyl methacrylate to the acrylic rubber particles, it is possible that the amount of the polymer mainly comprising the alkyl methacrylate be in a range of from about 95 to 40% by weight and the amount of the acrylic rubber particles be in a range of from about 5 to 60% by weight, respectively, provided that the total amount of the polymer and the particles is 100% by weight. When the amount of the acrylic rubber particles is excessively low, it becomes difficult to mold a composition into a film. When it is excessively high, the surface hardness of a film decreases. More preferably the amount of the acrylic rubber particles is about 10 parts or more by weight, per 100 parts by weight of the total amount of the polymer mainly comprising the alkyl methacrylate and the particles. Even more preferably, the amount of the acrylic rubber particles is 15 parts or more by weight in view of the effective prevention of the film breakage during a printing process or a simultaneous injection molding-lamination process. Furthermore, the resin composition composing the film substrate may contain other polymer components in an amount that can adversely affect the effect of the present invention.

The film substrate 1 may contain additives which would be generally used. Examples of such additives include: weathering stabilizers, such as hindered phenol antioxidants, phosphorus antioxidants, sulfur antioxidants, UV absorbers and hindered amine photostabilizers; flame retardants; coloring agents; pigments; inorganic fillers; etc. In a case where, for example, the film substrate is made of the above resin composition, these additives may be added during a step of kneading the polymer mainly comprising the alkyl methacrylate and the acrylic rubber particles, or alternatively may be previously compounded in the polymer mainly comprising the alkyl methacrylate and/or the acrylic rubber particles.

More preferably a UV absorber is added, which makes it possible to provide a laminated article with improved excellent weather resistance. As the UV absorber, for example, benzotriazole UV absorbers and benzophenone UV absorbers may be used singly or as a mixture of two or more of them. Specific examples of the benzotriazole UV absorbers include 2,2′-methylenebis[6-(2H-benzotriazol-2-yl)-4-(1,1,3,3-tetramethylbutyl)-phenol], 2-(2-hydroxy-5-methylphenyl)-2H-benzotriazole, 2-[2-hydroxy-3,5-bis(α,α-dimethylbenzyl)phenyl]-2H-benzotriazole, 2-(3,5-di-tert-butyl-2-hydroxyphenyl)-2H-benzotriazole, 2-(3-tert-butyl-2-hydroxy-5-methylphenyl)-5-chloro-2H-benzotriazole, 2-(3,5-di-tert-butyl-2-hydroxyphenyl)-5-chloro-2H-benzotriazole, 2-(3,5-di-tert-amyl-2-hydroxyphenyl)-2H-benzotriazole, 2-(2-hydroxy-5-tert-octylphenyl)-2H-benzotriazole, 2-[2-hydroxy-3-(3,4,5,6-tetrahydrophthalimidomethyl)-5-methylphenyl]-2H-benzotriazole, etc. Specific examples of the benzophenone UV absorbers include 2-hydroxy-4-methoxybenzophenone, 2-hydroxy-4-octoxybenzophenone, 2,4-dihydroxybenzophenone, 2-hydroxy-4-methoxy-4′-chlorobenzophenone, 2,2′-dihydroxy-4-methoxybenzophenone, 2,2′-dihydroxy-4,4′-dimethoxybenzophenone, etc. Among them, benzotriazole UV absorbers with a high molecular weight, such as 2,2′-methylenebis[6-(2H-benzotriazol-2-yl)-4-(1,1,3,3-tetramethylbutyl)-phenol)] are preferable, from a viewpoint of a decrease of the volatile components from the film and a prevention of deterioration of printed patterns.

The film substrate 1 is preferably produced by kneading the resin composing the film with additives optionally added, followed by film formation by, for example, extrusion casting using chill rolls or inflation extrusion molding. From a viewpoint of printability and thickness accuracy, it is preferable to produce a film by employing; an extrusion molding method in which both surfaces of the film are brought into contact with roll surfaces, or a belt cooling extrusion method in which both surfaces of the film are brought into contact with metal belts.

A matte resin film 10 can be produced by forming the matte layer 5 on at least one surface of the substrate film 1 produced as described above so that the matte resin film can obtain the above-described optical properties. The matte layer 5 preferably includes a layer comprising a transparent resin and transparent fine particles dispersed therein.

The transparent fine particles preferably have a refractive index difference (|Nd−Nb|) between a refractive index Nd of the transparent fine particles and a refractive index Nb of the transparent resin not greater than 0.02, more preferably not greater than 0.01, further preferably not greater than 0.005. If the refractive index difference |Nd−Nb| is excessively large, the haze of a film tends to increase. As a result, the inequality: H<70(%)−Gs may not be satisfied.

The refractive index of the transparent fine particles can be measured by Abbe refractometer by a method according to JISK 7105.

The volume-average particle diameter of the transparent fine particles can be measured by a measuring apparatus “Coulter Multisizer” (manufactured by Beckman Coulter, Inc.).

The volume-average particle diameter of the transparent fine particles is preferably in a range of from 0.5 to 10 μm, more preferably from 1 to 6 μm, and further preferably from 2 to 4 μm. If the volume-average particle diameter is excessively small, the thickness of the matte layer should be made thinner, and it becomes difficult to maintain enough strength of the matte layer. If the volume-average particle diameter is excessively large, the thickness of the matte layer should be made thicker depending on the particle size. As a result, it is technically difficult to form the matte resin layer thereon since its thickness is out of a range where the coating thickness can be generally attained. This is not economical.

As the transparent fine particles, for example, talc, glass beads, silicone particles, etc. as well as crosslinked acrylic or styrene particles can be used. Among them, crosslinked acrylic particles are preferably used in view of easy control of the refractive index and particle size.

The crosslinked acrylic particle means a particle made of a copolymer prepared by copolymerizing a monofunctional monomer mainly comprising an alkyl acrylate, with a polyfunctional monomer.

The alkyl acrylate, the monofunctional monomer, and the polyfunctional monomer may be selected, respectively, from the substances which can be used as the crosslinked acrylic particle contained in the resin film substrate.

Preferably, the crosslinked acrylic particle is a particle made of a copolymer prepared by copolymerizing 90 parts of a methyl methacrylate with 10 parts of ethylene glycol dimethacrylate.

Examples of methods of producing the crosslinked acrylic particle include, for example, an emulsion polymerization method, a suspension polymerization method, a seed polymerization method, and a dispersion polymerization method.

Examples of the transparent resin include such as acrylic resins, epoxy resins, ester resins, urethaneacrylate resins and silicone acrylate resins. Among them, urethaneacrylate resins are preferably used in view of followability to the elongation of the film substrate.

The matte layer 5 may be formed by applying a coating composition prepared by dispersing transparent fine particles into a transparent resin or a raw material on one surface of the substrate film 1 that the matte layer 5 is to be formed on. The coating composition may be applied by any known method, such as die coating, gravure coating, roll coating, blade coating, dip coating, flow coating, and so on. The matte layer 5 can be formed by drying the coating film formed thereon to evaporate a solvent from the coating film. In this case, by adjusting the composition of the paint or the thickness of each of the coating film and the matte layer 5, the matte resin film 10 can obtain the predetermined optical properties as described above.

The thickness of the matte layer 5 is preferably from 2 to 5 times the volume-average particle diameter of the fine particles, more preferably from 2.5 to 3 times. When the thickness of the matte layer is within this range, a matte resin film with a good matting performance as well as a high transparency, that is, a matte resin film with a low haze despite its less gloss can be produced. This is because the transparent fine particles are contained in the matte layer so that moderate unevenness is formed on the surface of the matte layer. If the thickness of the matte layer is excessively small relative to the volume-average particle diameter of the transparent fine particles, the transparent fine particles will protrude from the surface of the matte layer, and as a result of that, the haze of the film increases in spite of the gloss not being lowered sufficiently. This is because a part of incidence light is strongly scattered by such transparent fine particles. If the thickness of the matte layer is excessively large relative to the volume-average particle diameter of the transparent fine particles, a large amount of the transparent fine particles and the coating composition are needed to obtain the desired gloss level, which is not economical.

The whole thickness of the matte resin film 10 thus produced is preferably in a range of from about 40 to about 800 μm, more preferably from about 50 to about 500 μm. When the matte layer 5 is formed only on one surface of the matte film 10, a pattern may be printed on the other surface 7 of the matte film 10, or alternatively the film substrate 1 itself may be colored to impart the designability. When the matte layers 5 are formed on both surfaces of the matte film 10, the film substrate 1 itself may also be colored to impart the designability. The matte resin film 10 thus produced is desirable since a matting performance upon molding can be retained due its excellent molding processability. And thus it is preferably used in a surface coating method including the simultaneous injection molding-lamination method.

Furthermore, the matte resin film 10 may have a pressure-sensitive adhesive layer or an adhesive layer on one surface thereof. Such a layer may be readily formed on the matte resin film 10 by coating the pressure-sensitive adhesive or the adhesive to the desired surface of the film. When the matte layer 5 is formed only on one surface of the film substrate 1, the pressure-sensitive adhesive layer or the adhesive layer may be formed on the surface on which the matte layer 5 is formed or on the opposite surface which is an unmatted smooth surface 7. When the matte layer 5 is formed on one surface, in general, the pressure-sensitive adhesive layer or the adhesive layer is advantageously formed on the opposite surface 7.

In the case of a film having the matte layer 5 only on one surface thereof, when a pattern is printed on the surface 7 having no matte layer, making use of a feature that the surface 7 is smooth, the printing may be carried out by, for example, gravure printing, screen printing or printing using an ink jet printer which utilizes a computer graphic technology. In the case that the pattern is printed on the smooth surface 7 having no matte layer, by forming a pressure-sensitive adhesive layer on the printed layer, such a film can be used as a marking film.

The marking film means a film on which patterns such as various kinds of letters, symbols and photographs are to be printed and which is to be adhered to surfaces of various structural objects. The marking film may be used for advertisements, propagandas, warnings and displays, etc., and thus usable for, for example, outdoor advertisement boards; guiding signs (such as signs in stations); markings for various kinds of vehicles such as passenger vehicles, trucks, buses, railway cars (such as electric trains and passenger cars); markings for automatic vending machines; markings for wooden walls of factories and construction sites; markings for shutters and outer walls; markings for construction machineries; markings for ships; and decorative displays for in-line members of passenger vehicles, trucks, bicycles and light electrical parts. As marking films, flexible vinyl chloride resin films, polyurethane resin films and polyethylene terephthalate films have been conventionally used. However, when the resin film used as a substrate is made of an acrylic resin film in the present invention, it has an excellent weather resistance and light fastness in comparison with the conventional marking films.

The matte film of the present invention can be laminated on the other film or sheet to produce a multilayer film or sheet. In this case, the matte film is laminated on the other film or sheet so that the matte layer 5 lies at the top surface of the multilayer film or sheet. When the matte layer 5 is formed on one surface of the film substrate 1, the other film or sheet may be laminated on the surface 7 opposite to the matte layer 5. When the matte layers 5 are formed on both surfaces of the film substrate 1, the other film or sheet may be laminated on either one of two surfaces of the matte film. Examples of the resin composing the other film or sheet include: such as acrylic resins; flexible vinyl chloride resins; polyurethane resins; polyester resins such as polyethylene terephthalate; and polyolefin resins. A pattern may be printed on a top surface of the other film or sheet. In the case of making a multilayer film or sheet, for example, a so-called lamination method such as a method comprising molding a thermoplastic resin in the form of a film or a sheet in advance and then continuously laminating the resultant film or sheet and the matte film of the present invention by passing them between heat rolls, a method comprising thermally bonding the other film or sheet and the matte film of the present invention with a press, or a wet lamination method comprising inserting an adhesive layer to between the other film or sheet and the matte film of the present invention, can be employed.

Such a multilayer film may also be used as a marking film by forming a pressure-sensitive adhesive layer on the surface opposite to the side having the matte film thereon. In the case that the multilayer film is used as the marking film, after the matte layer 5 is formed on one surface of the film substrate 1 to constitute the matte film 10 of the present invention, a pattern may be printed on the surface 7 opposite to the matte layer 5, or alternatively a pattern may be printed on a side of the other film, the side being subject to an adhesion to the matte film 10, or a pattern may be printed on a side of the other film, the side being opposite to the side which is subject to an adhesion to the matte film 10.

Furthermore, the matte film, the matte film having the matte layer on one surface and the printed pattern on the other surface, or the multilayer film or sheet including other film or sheet and the matte film which is laminated on the other film or sheet in such a manner that the matte layer lie at the top surface of the multilayer film or sheet, according to the present invention, may be laminated on the top surface of the thermoplastic resin molded article by, for example, a simultaneous injection molding-lamination method. In any case, lamination is usually carried out in such a manner that the matte layer of the matte film lies at the outermost side. Examples of the thermoplastic resin suitable for laminating the matte film or multilayer film or sheet having the matte film of the present invention include polyolefin resins, vinyl chloride resins, acrylonitrile-butadiene-styrene copolymers (ABS resin), polyurethane resins and acrylic resins.

The simultaneous injection molding-lamination method may be carried out by one of methods comprising inserting the above film or sheet, which has not been pre-molded, into an injection mold, injecting a resin melt therein, and forming an injection molded article with simultaneously laminating the film or sheet on the molded article (this method is sometimes referred to as a narrowly-defined simultaneous injection molding-lamination method); a method comprising firstly pre-molding the above film or sheet by vacuum forming or pressure forming, inserting the pre-molded resin film into an injection mold, injecting a hot-melt resin therein, and laminating the film or sheet on the molded article with simultaneously forming the injection molded article (this method is sometimes referred to as an insert molding method); a method comprising firstly pre-molding the above film or sheet by vacuum forming or pressure forming in an injection mold, injecting a hot-melt resin in the mold, and laminating the film or sheet on the molded article with simultaneously forming the injection molded article (this method is sometimes referred to as an in-mold method); or the like. The details of the simultaneous injection molding-lamination method are described in JP-B-63-6339, JP-B-4-9647 and JP-A-7-9484.

### EXAMPLE

Hereinafter, the present invention will be described in more detail by making reference to the Examples, which do not limit the scope of the present invention in any way. In the examples, “parts” expressing the amounts of materials are “parts by weight” unless otherwise specified herein.

### Examples 1 to 17

### Comparative Examples 1 to 10

### A Method of Manufacturing of Acrylic Resin Film

As the polymer mainly comprising the alkyl methacrylate, an acrylic resin was used. The acrylic resin was produced by bulk polymerization, and comprises of 99% by weight of methyl methacrylate units and 1% by weight of methyl acrylate units and has a glass transition temperature of 105° C., a weight-average molecular weight of about 140,000. The glass transition temperature was an extrapolated glass transition starting temperature measured at a heating rate of 10° C./min. by differential scanning calorimetry according to JIS K7121. The weight-average molecular weight was measured by GPC using three columns connected in series: TSKgel GMH_{HR}-H (7.8 mmφ×300 mm) (manufactured by Tosoh Corporation) under the following conditions:

Solvent: tetrahydrofuran

### Temperature: 40° C.

### Detector: RI

Flow rate: 1.0 ml/min. Standard PMMA samples were used as molecular weight standards.

Acrylic rubber particles used were produced according to Example 3 of U.S. Pat. No. 3,793,402, the disclosure of which is hereby incorporated by reference. The acrylic rubber particles had a spherical three-layer structure including an innermost layer made of a hard polymer prepared by polymerizing methyl methacrylate and a small amount of allyl methacrylate, an intermediate layer made of an elastic polymer prepared by polymerizing butyl acrylate as a primary component, styrene and a small amount of allyl methacrylate, and an outermost layer made of a hard polymer prepared by polymerizing methyl methacrylate and a small amount of ethyl acrylate. The particles had an average particle diameter of about 210 nm when they were mixed with a matrix resin.

As the ultraviolet absorber, 2,2′-Methylene-bis[6-(2H-benzotriazol-2-yl)-4-(1,1,3,3-tetramethylbutyl)phenol](ADEKASTAB LA-31 produced by ADEKA Corporation) was used.

Eighty parts of the acrylic resin, 20 parts of the rubber particles, and 0.5 part of the ultraviolet absorber were mixed with a tumbler mixer and melt-kneaded with a unidirectional rotation type twin screw extruder while keeping the temperature of the resin at 255° C. to pelletize. Next, the pellets of the acrylic resin composition were extruded through a T type film die (lip clearance: 0.5 mm; width: 600 mm; preset temperature: 250° C.) using a single screw extruder (barrel diameter 65 mmφ; manufactured by Toshiba Machine Co., Ltd.) while bringing both surfaces of the film in complete contact with cooling polishing rolls to obtain an acrylic resin film having a thickness of 75 μm.

### (Measurement of Refractive Index of Transparent Resin Composing Matte Layer)

Ten parts of a paint containing acrylpolyol [Topcoat PTC-NT U-605 Medium (A) manufactured by Dainichiseika Color & Chemicals Mfg. Co., Ltd.] was mixed with 1 part or 2 parts of an isocyanate curing agent [Topcoat No. 73 manufactured by Dainichiseika Color & Chemicals Mfg. Co., Ltd.]. Respectively, the mixtures were applied onto glass substrates, and the glass plates were allowed to stand in an oven of 60° C. for 2 hours for drying and curing to obtain transparent resins. When a cut piece of each of the transparent resins was dipped in a standard solution having a refractive index of 1.496 and observed with an optical microscope, the outline of the section was disappeared. In a case where standard solutions having a respective refractive index of 1.492 and 1.500 were used, the outline of the section was obserbed. Based on the above observations, the refractive index Nb of the transparent resin in the matte layer was judged to be 1.496±0.002 when the curing agent was used in an amount of 1 part or 2 parts relative to 100 parts of the paint. Hereinafter, by using the paint and the curing agent as have been set in such range, the matte layer was formed.

### (Formation of a Matte Layer)

The following particles were used as crosslinked particles:

Crosslinked particles (A): XX-66K (refractive index Nd=1.495, volume-average particle diameter 2.7 μm, a copolymer of methyl methacrylate-divinyl benzene) manufactured by Sekisui Plastics Co., Ltd.)

Crosslinked particles (B): MBX-8 (refractive index Nd=1.495, volume-average particle diameter 7.9 μm, a copolymer of methyl methacrylate-divinyl benzene) manufactured by Sekisui Plastics Co., Ltd.)

Crosslinked particles (C): MBX-5 (refractive index Nd=1.495, volume-average particle diameter 5.1 μm, a copolymer of methyl methacrylate-divinyl benzene) manufactured by Sekisui Plastics Co., Ltd.)

Crosslinked particles (D): XX-235K (refractive index Nd=1.495, volume-average particle diameter 1.6 μm, a copolymer of methyl methacrylate-divinyl benzene) manufactured by Sekisui Plastics Co., Ltd.)

Crosslinked particles (E): MBX-12 (refractive index Nd=1.495, volume-average particle diameter 12 μm, a copolymer of methyl methacrylate-divinyl benzene) manufactured by Sekisui Plastics Co., Ltd.)

Crosslinked particles (F): XX-133K (refractive index Nd=1.525, volume-average particle diameter 5.0 μm, a copolymer of methyl methacrylate-styrene-divinyl benzene) manufactured by Sekisui Plastics Co., Ltd.)

Eighteen parts of crosslinked particles, 55 parts of the paint containing acrylpolyol (Topcoat PTC-NT U-605 Medium (A) manufactured by Dainichiseika Color & Chemicals Mfg. Co., Ltd.), and 7 parts of PTC-NT No. 2 manufactured by Dainichiseika Color & Chemicals Mfg. Co., Ltd. shown in Table 1 ware mixed to prepare a dispersion of transparent fine particles. The dispersion of the transparent fine particles (referred to as “dispersion” solely in Table 1), the paint containing acrylpolyol (referred to as “paint” solely in Table 1, Topcoat PTC-NT U-605 Medium (A) manufactured by Dainichiseika Color & Chemicals Mfg. Co., Ltd.), the isocyanate curing agent (referred to as “curing agent” solely in Table 1, Topcoat No. 73 manufactured by Dainichiseika Color & Chemicals Mfg. Co., Ltd.), and the solvent (PTC-NT No. 2 manufactured by Dainichiseika Color & Chemicals Mfg. Co., Ltd.) were mixed in the ratio by weight as shown in Table 1. The mixed paint was applied on the one surface of the acrylic resin film produced as described above, using a bar coater of Table 1. And subsequently it was allowed to stand in an oven of 60° C. for 2 hours for drying and curing to obtain a matte resin film having the matte layer on one side thereof.

A haze value H of the resultant matte resin film was measured according to JIS K7136 by using HR-100 (manufactured by Murakami Color Research Laboratory Co., Ltd.). A 60-degree specular gloss Gs of the matte surface were measured according to JIS K7105 by using a gloss meter GM-268 (manufactured by Konicainolta Holdings Inc.). In addition, the shortest distance from a boundary of a matte layer and a substrate film layer (acrylic resin film layer) to a top surface of the matte layer was measured with a field emission scanning electron microscope FE-SEM S-4200 (manufactured by Hitachi Ltd.), and this distance was used as the thickness of the matte layer. These results are shown in Table. 1.

TABLE 1

| | | | | Paint | Curing | | | | | |
|---|---|---|---|---|---|---|---|---|---|---|
| | Crosslinked | Bar | Dispersion | agent | agent | Solvent | Gs | H | | Thickness |
| Example | Particle | coater | (parts) | (parts) | (parts) | (parts) | (%) | (%) | 70-Gs | (μm) |
| Example 1 | (A) | #16 | 19 | 31 | 5 | 3 | 28.9 | 28.2 | 41.1 | 11 |
| Example 2 | (A) | #16 | 19 | 31 | 5 | 6 | 24.4 | 38.1 | 45.6 | 10 |
| Example 3 | (A) | #16 | 19 | 31 | 5 | 9 | 22.8 | 44.1 | 47.2 | 6 |
| Example 4 | (A) | #16 | 16 | 34 | 5 | 3 | 30.5 | 28.2 | 39.5 | 11 |
| Example 5 | (A) | #16 | 16 | 34 | 5 | 6 | 29.2 | 38.2 | 40.8 | 6 |
| Example 6 | (B) | #20 | 6 | 4 | 1 | 2 | 20.1 | 46.7 | 49.9 | 20 |
| Example 7 | (B) | #20 | 4 | 6 | 1 | 2 | 29.0 | 34.0 | 41.0 | 18 |
| Example 8 | (B) | #20 | 2 | 8 | 1 | 2 | 39.2 | 22.2 | 30.8 | 18 |
| Example 9 | (C) | #16 | 10 | 0 | 1 | 2 | 23.2 | 40.9 | 46.8 | 12 |
| Example 10 | (C) | #16 | 8 | 2 | 1 | 2 | 28.6 | 29.0 | 41.4 | 12 |
| Example 11 | (C) | #16 | 6 | 4 | 1 | 2 | 36.6 | 22.1 | 33.4 | 12 |
| Example 12 | (D) | #8 | 10 | 0 | 1 | 2 | 13.0 | 54.9 | 57.0 | 5 |
| Example 13 | (D) | #8 | 8 | 2 | 1 | 2 | 21.7 | 32.5 | 48.3 | 5 |
| Example 14 | (D) | #8 | 6 | 4 | 1 | 2 | 34.2 | 19.5 | 35.8 | 4 |
| Example 15 | (E) | #30 | 6 | 4 | 1 | 2 | 14.0 | 51.2 | 56.0 | 26 |
| Example 16 | (E) | #30 | 4 | 6 | 1 | 2 | 24.3 | 41.7 | 45.7 | 25 |
| Example 17 | (E) | #30 | 2 | 8 | 1 | 2 | 35.0 | 28.3 | 35.0 | 27 |
| Comparative | (A) | #16 | 19 | 31 | 5 | 12 | 22.6 | 51.6 | 47.4 | 5 |
| Example 1 | | | | | | | | | | |
| Comparative | (A) | #16 | 19 | 31 | 5 | 15 | 20.3 | 56.8 | 49.7 | 4 |
| Example 2 | | | | | | | | | | |
| Comparative | (A) | #16 | 16 | 34 | 5 | 12 | 28.1 | 46.6 | 41.9 | 5 |
| Example 3 | | | | | | | | | | |
| Comparative | (A) | #16 | 16 | 34 | 5 | 15 | 29.1 | 47.0 | 40.9 | 3 |
| Example 4 | | | | | | | | | | |
| Comparative | (B) | #6 | 4 | 6 | 1 | 2 | 21.6 | 59.8 | 48.4 | 5 |
| Example 5 | | | | | | | | | | |
| Comparative | (B) | #6 | 2 | 8 | 1 | 2 | 30.3 | 42.7 | 39.7 | 5 |
| Example 6 | | | | | | | | | | |
| Comparative | (B) | #6 | 1 | 9 | 1 | 2 | 41.6 | 30.5 | 28.4 | 5 |
| Example 7 | | | | | | | | | | |
| Comparative | (F) | #16 | 10 | 0 | 1 | 2 | 23.1 | 59.4 | 46.9 | 11 |
| Example 8 | | | | | | | | | | |
| Comparative | (F) | #16 | 8 | 2 | 1 | 2 | 33.4 | 48.4 | 36.7 | 12 |
| Example 9 | | | | | | | | | | |
| Comparative | (F) | #16 | 6 | 4 | 1 | 2 | 42.6 | 41.0 | 27.4 | 11 |
| Example 10 | | | | | | | | | | |

### (Evaluation of the Pattern)

A matte black paint (Mr. COLOR 33 manufactured by GSI Creos Corporation) was applied onto the surface opposite to the matte surface of each of the matte resin films produced in Examples 1 to 17 and Comparative Examples 1 to 10, and the black paint was observed visually from the side of the matte surface. When the films having a close 60-degree specular gloss Gs were mutually compared, clear black color with less whiteness was observed in the Examples of the present invention as compared to that of Comparative Examples. For example, in Examples 1, 4, and 5, clear black color with less whiteness was observed as compared to that of Comparative Examples 3 and 4. In Example 3, clear black color with less whiteness was observed as compared to that of Comparative Example 1. Further, in Example 6, clear black color with less whiteness was observed as compared to that of Comparative Example 5. In Example 7, clear black color with less whiteness was observed as compared to that of Comparative Example 6. Moreover, in Example 8, clear black color with less whiteness was observed as compared to that of Comparative Example 7. In addition, in the film of Example 9 as compared to that of Comparative Example 8, clear black color with less whiteness was observed in spite that a 60-degree specular gloss (Gs) of the film of Example 9 is close to or lower than that of Comparative Example 8. Furthermore, in the film of Example 10 as compared to that of Comparative Example 9, clear black color with less whiteness was observed in spite that a 60-degree specular gloss (Gs) of the film of Example 10 is close to or lower than that of Comparative Example 9. Moreover, in the film of Example 11 as compared to that of Comparative example 10, clear black color with less whiteness was observed in spite that a 60-degree specular gloss (Gs) of the film of Example 11 is close to or lower than that of Comparative Example 10.

What is claimed is:

1. A matte resin film comprising:
a resin film substrate; and
a matte layer formed on at least one surface of the resin film substrate,
wherein the matte layer has a top surface that has a 60-degree specular gloss Gs being in a range of 5% to 60%, and
wherein the matte resin film has a haze H that satisfies the inequality: H<70(%)−Gs.

2. The matte resin film according to claim 1, wherein the matte layer comprises a transparent resin and transparent fine particles dispersed therein.

3. The matte resin film according to claim 2, wherein the transparent fine particles have a refractive index Nd and the transparent resin has a refractive index Nb, the difference between Nd and Nb, |Nd−Nb|, being 0.02 or less.

4. The matte resin film according to claim 2, wherein a volume-average particle diameter of the transparent fine particles is in a range of 0.5 to 10 μm.

5. The matte resin film according to claim 2, wherein the thickness of the matte layer is 2 to 5 times the volume-average particle diameter of the transparent fine particles.

6. The matte resin film according to claim 2, wherein the transparent fine particles are crosslinked acrylic resin particles.

7. The matte resin film according to claim 1, wherein the resin film substrate is an acrylic resin film which comprises a resin composition containing: a polymer mainly comprising an alkyl methacrylate; and acrylic rubber particles.

8. The matte resin film according to claim 7, wherein the polymer mainly comprising the alkyl methacrylate comprises at least one polymer selected from the group consisting of a homopolymer of an alkyl methacrylate and a copolymer of an alkyl methacrylate and an alkyl acrylate.

9. The matte resin film according to claim 7, wherein the polymer mainly comprising the alkyl methacrylate has a glass transition temperature being in a range of 60° C. to 110° C., and a weight-average molecular weight being in a range of 70,000 to 600,000.

10. The matte resin film according to claim 7, wherein the acrylic rubber particles are multilayer structure particles comprising:
a layer made of a rubber elastic material comprising a copolymer of an alkyl acrylate having 4 to 8 carbon atoms in its alkyl moiety and a polyfunctional monomer; and
a layer made of a hard polymer mainly comprising methyl methacrylate, the layer made of the hard polymer being formed around the layer made of the rubber elastic material.

11. The matte resin film according to claim 7, wherein the acrylic rubber particles have an average particle diameter of from 50 to 500 nm.

12. The matte resin film according to claim 1, having a total thickness being in a range of 40 to 800 μm.

13. The matte resin film according to claim 1, wherein the matte layer is formed on one surface of the resin film substrate, and a pattern is printed on the other surface of the resin film substrate.

14. A marking film comprising:
a matte resin film according to claim 13; and
a pressure-sensitive adhesive layer formed on a surface, having a printed pattern thereon, of the matte resin film.

15. A multilayer film or sheet comprising:
the matte resin film according to claim 1, and
a film or sheet laminated on a surface of the matte resin film opposite to the matte layer,
wherein the matte layer of the matte resin film lies at a top surface of the multilayer film or sheet.

16. A laminated article comprising:
a molded article made of a thermoplastic resin, and
the matte resin film according to claim 1 or the multilayer film or sheet according to claim 15, the matte resin film or the multilayer film or sheet being laminated on the molded article in such a manner that the matte layer thereof lies at a top surface of the laminated article.
